(19) United States
(12) Patent Application Publication
(10) Pub. No.: US 2008/0095446 A1
(43) Pub. Date: Apr. 24, 2008

(54) Method and system for performing image processing in a computer apparatus

(75) Inventors: Jui-Ming Chen, Taoyuan City (TW); Li-Ming Chen, Keelung City (TW); Ji-Jeng Deng, Taipei City (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 11/907,987

(22) Filed: Oct. 19, 2007

(30) Foreign Application Priority Data
Oct. 24, 2006 (TW) 095139159

(51) Int. Cl. G06K 9/56

(52) U.S. Cl. 382/205

(57) ABSTRACT

A method and system for performing image processing in a computer apparatus. The system has an image driver unit to receive a video stream output by an image capture device and perform a pre-processing on the video stream to thereby obtain a color video stream, and an image processing module to use an application programming interface (API) to notify the image driver unit of outputting the color video stream in order to perform a special effect processing on the color video stream to thereby produce a processed video stream. The image processing module uses another API to notify the image driver unit and send the processed video stream to the image driver unit. The image driver unit performs a post-processing on the processed video stream. Accordingly, the image processing module can use the resources of a user mode to perform the complicated image processing operations.

### BACKGROUND OF THE INVENTION

1. Field of the Invention

The invention relates to the technical field of image processing and, more particularly, to a method and system for performing image processing using existent resources of a user mode in a computer apparatus.

2. Description of Related Art

Personal computer (PC) cameras are priced cheap and thus almost become basic equipment in a PC or notebook. In addition, an internet messenger software can be applied in a PC camera to send an image in real-time and further add the various applications. For example, an image captured by the PC camera is combined with a special background or used to be interactive with a user.

However, in the PC cameras, a source image and a background are combined in the application program (AP) layer. FIG. 1 is a schematic diagram of a typical configuration with a Microsoft Direct Show document. As shown in FIG. 1, filters with user definitions for special effects can be added between the Windows driver model (WDM) capture device and the display card. Accordingly, before an image captured by a PC camera is output to the display card, the filters can add certain special effect processing operations, such as face-changing effects or special effects desired by a user, to further obtain the expected result.

However, the application programs in such a way have to add a user-defined filter (such as a face-changing filter) between the source filter and the render filter. Typical Internet messengers (such as MSN, Netmeeting, Amcap, and the like) or prepared application programs have no such a user-defined filter, so that the functions of the user-defined filter cannot be applied by the messengers and the application programs.

To overcome this, another solution is provided, which adds the filters with special effects in a driver. Accordingly, an image output from the source filter is a processed image, and an Internet messenger can properly use the filter with the special effects. FIG. 2 is a schematic diagram of a typical driver using a filter with special effects. As shown in FIG. 2, a WDM capture device captures a video stream and sends the video stream through a stream interface to a driver at kernel mode. The driver at kernel mode pre-processes the video stream. For example, a user inputs a frog picture, an application program at user mode converts the frog picture into an parameter Id=1 and sends the parameter through a program interface “Property Set” to the driver at kernel mode. The driver at kernel mode identifies the frog picture as a background frog in accordance with the parameter Id=1, and pastes the frog picture on the background. The driver at kernel mode performs a post-processing, and the video stream after the post-processing is sent to an application program at user mode. Therefore, the Internet messenger can perform a special effect processing on the video stream output by the WDM extractor.

However, since all the special effects are processed at kernel mode, the resources, such as bitmap enlargement and shrinking, and 3D image processing, at user mode cannot be used. A variety of software, such as Direct 3D, Windows APIs, can be used for development and used at user mode. Accordingly, if the special effect processing can be performed at kernel mode only, the utility of special effects is limited. In addition, when the coding of the driver is complete, the special effects possessed by the driver are fixed. For adding, deleting or modifying a special effect, the driver has to be re-coded, and the user has to update the driver re-coded. Therefore, it is desirable to provide an improved driver to mitigate and/or obviate the aforementioned problems.

### SUMMARY OF THE INVENTION

An object of the invention is to provide a method and system for performing image processing in a computer apparatus, which can directly use a new image special effect without replacing the image driver of a used image capture device.

Another object of the invention is to provide a method and system for performing image processing in a computer apparatus, which can change an image processing from kernel mode into user mode, such that resources at the user mode can be used to perform the complicated image processing and operations.

A further object of the invention is to provide a method and system for performing image processing in a computer apparatus, which can perform an image processing and is fully compatible with the Internet messengers.

In accordance with one aspect of the present invention, there is provided a method for performing image processing in a computer apparatus. The computer apparatus includes an image capture device, an image driver unit, an image processing module and an operating system. The operating system has a user mode and a kernel mode. The method includes the steps: an image receiving step, a first image delivering step, an image processing step, and a second image delivering step. The image receiving step uses the image driver unit to receive a video stream from the image capture device. The image driver unit performs a pre-processing on the video stream to thereby obtain a color video stream. The first image delivering step uses the image driver unit to send the color video stream to the image processing module, wherein the image driver unit is performed at the kernel mode, and the image processing module is performed at the user mode. The image processing step uses the image processing module to perform a special effect processing on the color video stream to thereby produce a processed video stream. The second image delivering step uses the image processing module to send the processed video stream to the image driver unit. The image driver unit performs a post-processing on the processed video stream.

In accordance with another aspect of the present invention, there is provided a system for performing image processing in a computer apparatus. The computer apparatus includes an operating system with a user mode and a kernel mode. The system includes an image capture device, an image driver unit and an image processing module. The image capture device has an image extractor and a connection interface. The image extractor extracts a video stream. The connection interface sends the video stream to the image driver unit. The image driver unit performs a pre-processing and a post-processing. The image driver unit performs a pre-processing on the video stream at the kernel mode, to thereby obtain a color video stream. The image processing module is connected to the image driver unit in order to perform a special effect processing at the user mode on the color video stream, to thereby produce a processed video stream. The image processing module sends the processed video stream to the image driver unit. The image driver unit performs the post-processing on the processed video stream to thereby produce a post-processed video stream to an application program performed at the user mode.

### BRIEF DESCRIPTION OF THE DRAWINGS

FIG. 1 is a schematic diagram of a typical configuration with a Microsoft Direct Show document;

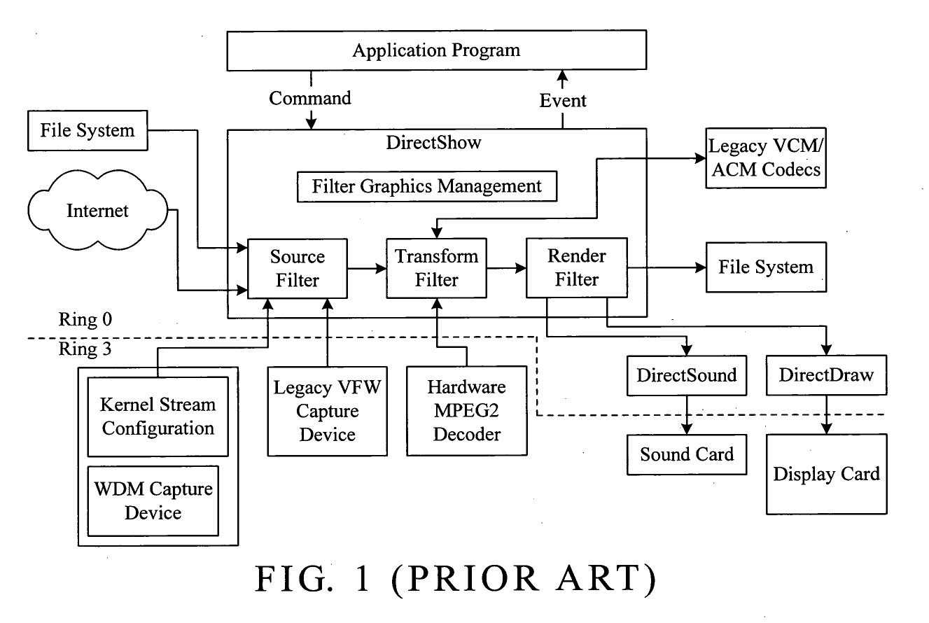

FIG. 2 is a schematic diagram of a typical driver using a filter with special effects;

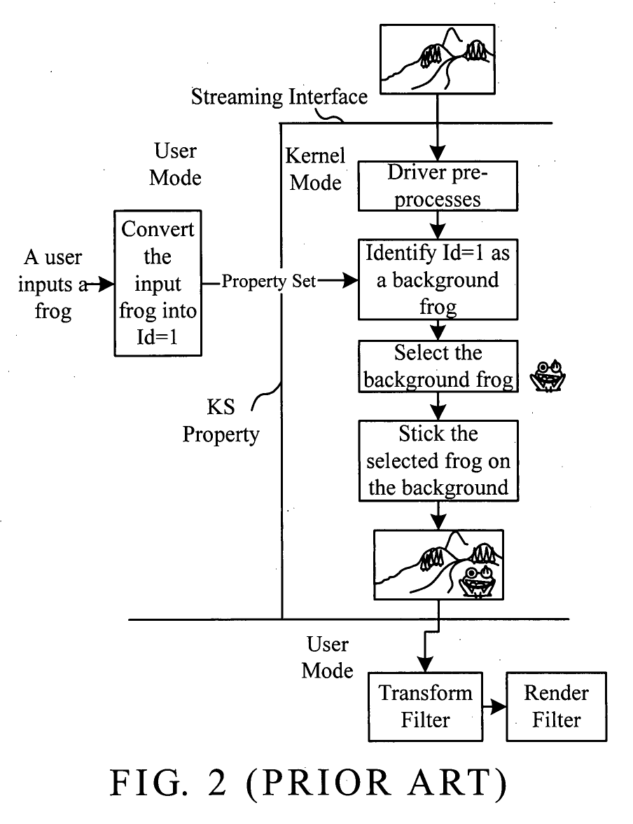

FIG. 3 is a schematic diagram of a system for performing image processing in a computer apparatus in accordance with the invention;

FIG. 4 is a schematic diagram of a Bayer color filter array and associated interpolation in accordance with the invention;

FIG. 5 is a flowchart of a method for performing image processing in a computer apparatus in accordance with the invention;

FIG. 6 is a schematic diagram of an operation of FIG. 5 in accordance with the invention;

FIG. 7 is a graph of partial codes of an image driver unit in accordance with the invention; and

FIG. 8 is a schematic diagram of a practical example of FIG. 5 in accordance with the invention.

### DETAILED DESCRIPTION OF THE PREFERRED EMBODIMENT

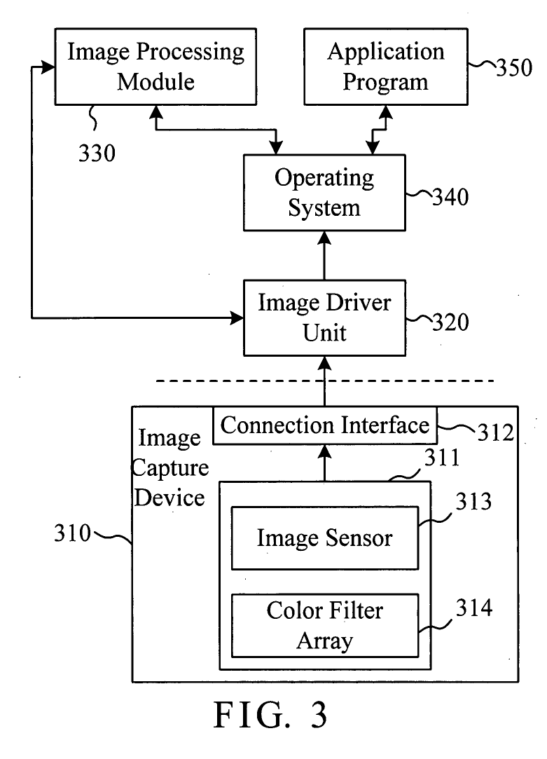

FIG. 3 is a schematic diagram of a system for performing image processing in a computer apparatus in accordance with the invention. The computer apparatus includes an operating system 340 with a user mode and a kernel mode. The operating system 340 is preferably a Windows 2000 or XP. The system includes an image capture device 310, an image driver unit 320 and an image processing module 330.

The image capture device 310 has an image extractor 311 and a connection interface 312. The image extractor 311 consists of an image sensor 313 and a color filter array (CFA) 314. The image extractor 311 can extract a video stream.

The connection interface 312 connects the image capture device 310 to the computer apparatus in order to send the video stream to the computer apparatus. The connection interface 312 can be an Ethernet, a wireless Ethernet, a universal serial bus (USB), a wireless USB, or an IEEE 1394 serial bus.

The image driver unit 320 can perform an image pre-processing and an image post-processing. The image driver unit 320 receives the video stream from the image capture device 310 and performs the pre-processing on the received stream to thereby obtain a color video stream, which is performed at the kernel mode.

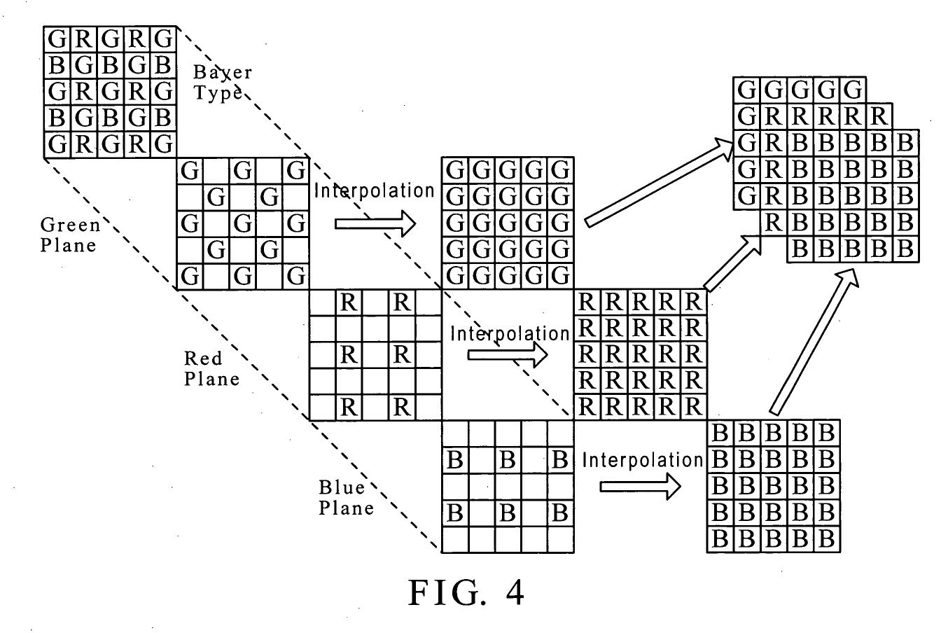

The pre-processing performed by the image driver unit 320 essentially applies a pixel interpolation operation to the video stream. FIG. 4 is a schematic diagram of a Bayer color filter array 314 and associated interpolation in accordance with the invention. As shown in FIG. 4, the frame is arranged by alternate GRGRGR and BGBGBG rows. The CFA 314 causes each photosite of the image sensor 313 to have a value of red, green or blue only, and thus an interpolation is applied to the photosites for reconstructing the other color values not existing.

The image processing module 330 is connected to the image driver unit 320 in order to perform a special effect processing on the color video stream to thereby produce a processed video stream. The image processing module 330 is performed at the user mode. The image processing module 330 uses an application programming interface (API), KS property Get, to notify the image driver unit 320 of sending the color video stream to the image processing module 330.

The special effect processing performed by he image processing module 330 can be an image enhancement, image restoration, image segmentation, image feature extraction, image edge detection, image morphological processing, image replacement processing or image merge processing.

In addition, the image processing module 330 uses an API, i.e., KS property Set, to notify the image driver unit 320 of receiving the processed video stream. The image processing module 330 sends the processed video stream to the image driver unit 320 for the post-processing. The image driver unit 320 sends the video stream after the post-processing to an application program 350 performed at the user mode. The post-processing performed by the image driver unit 320 can be an image brightness processing or image edge-enhance processing.

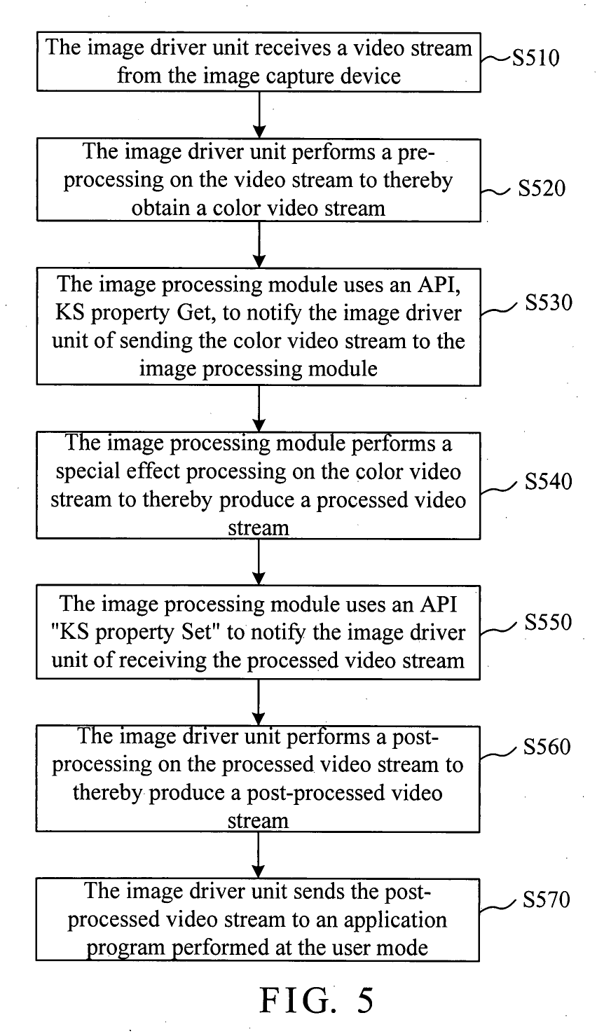

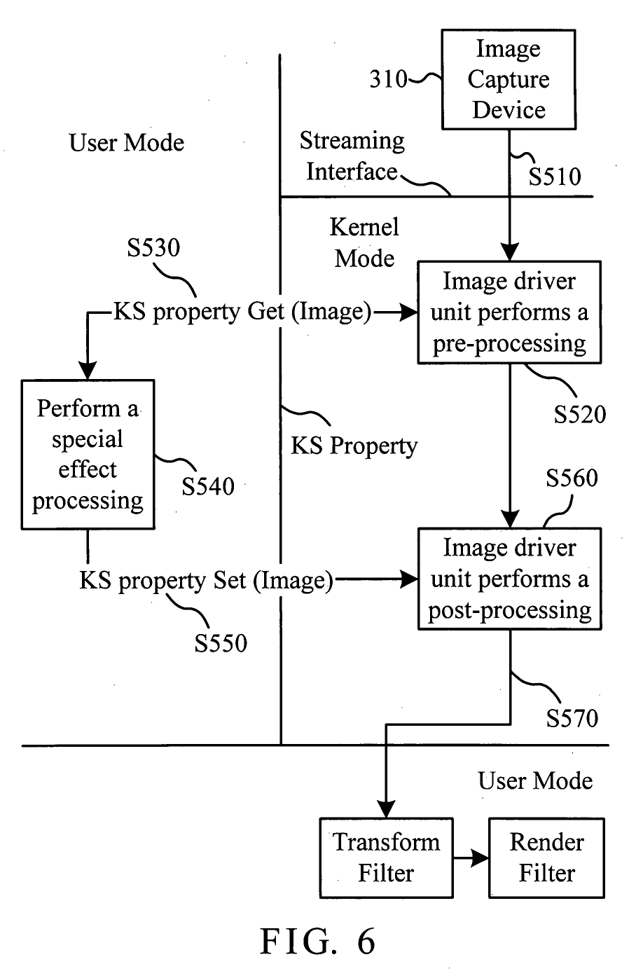

FIG. 5 is a flowchart of a method for performing image processing in a computer apparatus in accordance with the invention. FIG. 6 is a schematic diagram of an operation of FIG. 5 in accordance with the invention. The computer apparatus includes an image capture device 310, an image driver unit 320, an image processing module 330, and an operating system 340 with a user mode and a kernel mode. As shown in FIG. 5 and FIG. 6, the image driver unit 320 receives a video stream from the image capture device 310 (step S510). The image driver unit 320 performs a pre-processing on the video stream to thereby obtain a color video stream (step S520).

The pre-processing performed by the image driver unit 320 essentially applies a pixel interpolating operation, which uses an interpolation to reconstruct the other color values not existing in each photosite of the image sensor 313 of the image capture device 310.

In step S530, the image processing module 330 uses an application programming interface (API), KS property Get, to notify the image driver unit 320 of sending the color video stream to the image processing module 330. When the image processing module 330 sends the API “KS property Get” to the image driver unit 320, a corresponding “KS property” event is activated. The image driver unit 320 performs a set or get function in accordance with a set or get event. Namely, when the image processing module 330 uses the API “KS property Get” to notify the image driver unit 320, the image driver unit 320 performs the internal get function in order to put the color video stream to a common memory for sharing with the image processing module 330. The image driver unit 320 is performed at the kernel mode, and the image processing module 330 is performed at the user mode.

In step S540, the image processing module 330 performs a special effect processing on the color video stream to thereby produce a processed video stream. Since the image processing module 330 is performed at the user mode, it can use the software (such as Direct 3D, Windows APIs) developed at the user mode to perform the special effect processing. However, the problem in the prior art about the use of special effects is limited as the special effect processing is performed at the kernel mode. The special effect processing performed by the image processing module 330 can be an image enhancement, image restoration, image segmentation, image feature extraction, image edge detection, image morphological processing, image replacement processing or image merge processing.

In step S550, after the image processing module 330 performs the special effect processing on the color video stream, the image processing module 330 uses the API “KS property Set” to notify the image driver unit 320 of receiving the processed video stream. The image processing module 330 sends the processed video stream to the image driver unit 320 for the post-processing. When the image driver unit 320 use the API “KS property Set” to notify the image driver unit 320, the image driver unit 320 performs the internal set function in order to receive the processed video stream.

In step S560, the image driver unit 320 performs the post-processing on the processed video stream received to thereby produce a post-processed video stream. The post-processing performed by the image driver unit 320 can be an image brightness processing or image edge-enhance processing.

In step S570, the image driver unit 320 sends the post-processed video stream to an application program performed at the user mode.

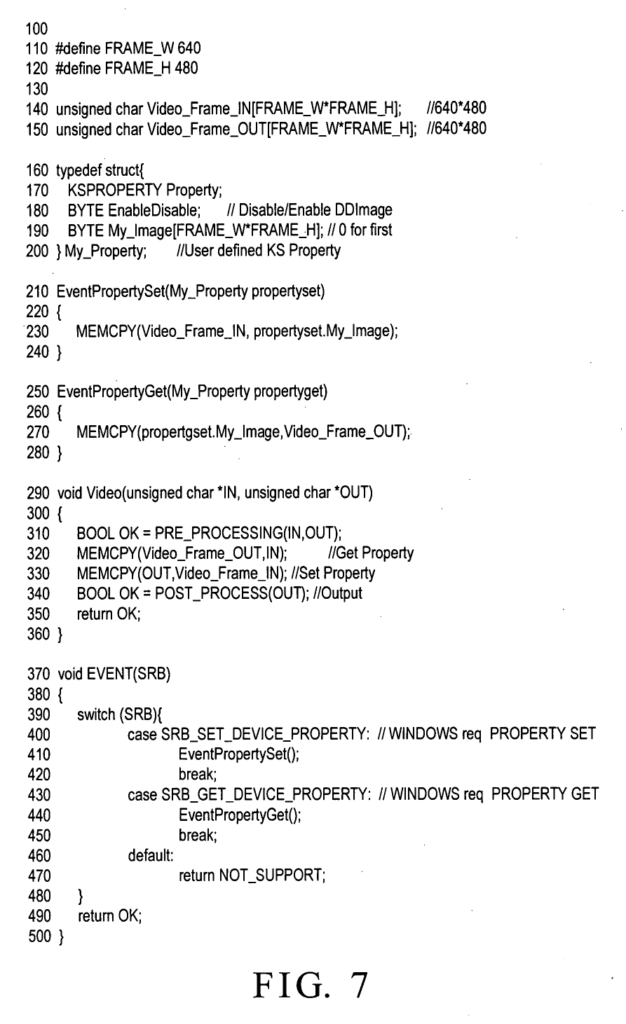

FIG. 7 is a graph of partial codes of the image driver unit 320 in accordance with the invention. For convenient description, the line number is added. As shown in FIG. 7, at lines 140-150, the image driver unit 320 defines two frame buffers, Video_Frame_IN and Video_Frame_OUT, which have a size of 640*480 respectively.

At lines 160-200, the image driver unit 320 declares a structure My_Property. The declared structure My_Property is a common structure shared by the image driver unit 320 and the image processing module 330, and the “KS property” structure (My_Property) defined by a user, which allows a communication between the image driver 320 and the image processing mode 330. For sending a video between the image driver unit 320 and the image processing module 330, a buffer My_Image with a size of 640*480 is defined, and an enable/disable switch is added.

At lines 370-480, the image driver unit 320 defines an event handling function EVENT(SRB). When the image processing module 330 uses the API “KS property Get”, the operating system 340 sends the corresponding event, i.e., SRB_GET_DEVICE_PROPERY, to the image driver unit 320 in accordance with the API “KS property Get”. Accordingly, the image driver unit 320 calls the get function EventPropertyGet( ) in order to copy the video stream from the image driver unit 320 to a common area to thus complete the get operation (lines 250-280). When the image processing module 330 uses the API “KS property Set” to send the corresponding event, i.e., SRB_SET_DEVICE_PROPERTY, to the image driver unit 320. Accordingly, the driver unit 320 calls the set function EventPropertySet( ) in order to copy the video stream from the common area to the image driver unit 320 to thus complete the set operation (lines 210-240).

At lines 290-360, the image driver unit 320 defines a video processing function Video( ). After the image capture device 310 inputs a video stream, the image driver unit 320 executes the function Video( ) for a video processing before the video stream is output to the application program (AP) 350 at the user mode. An argument IN indexes that the video stream is sent from the image capture device 310 to the image driver unit 320, and an argument OUT indexes that the image driver unit 320 is ready to output the video stream to the AP 350.

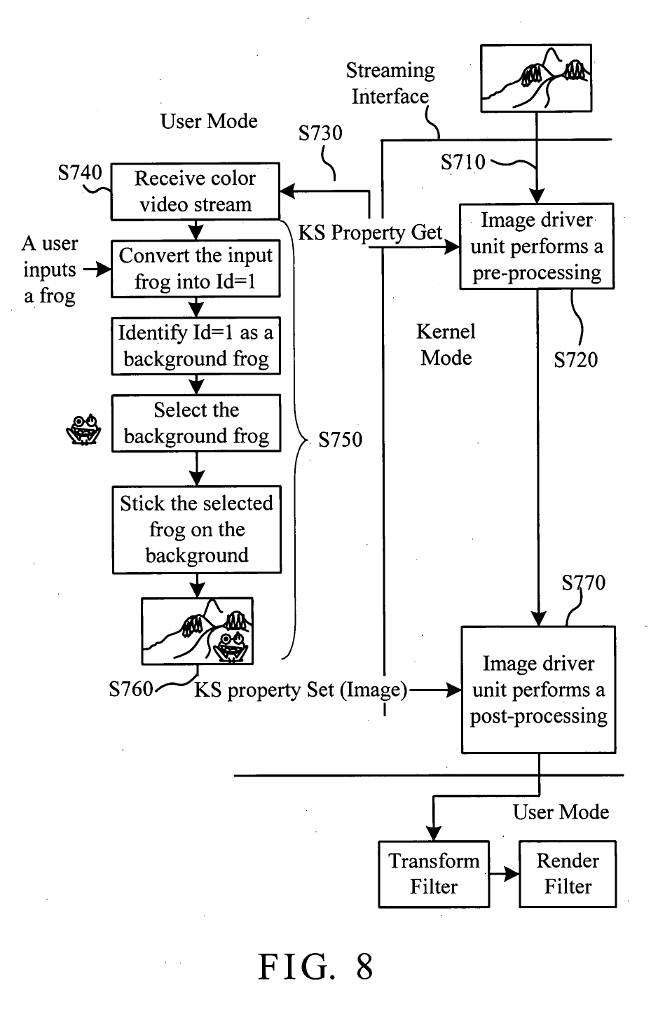

FIG. 8 is a schematic diagram of a practical example of FIG. 5 in accordance with the invention. As shown in FIG. 8, in step S710, the image driver unit 320 receives a video stream from the image capture device 310. The image driver unit 320 performs a pre-processing on the video stream (step S720) to thereby obtain a color video stream.

In step S730, the image processing module 330 uses an application programming interface (API), KS property Get, to notify the image driver unit 320 of sending the color video stream to the image processing module 330. In step S740, the image processing module 330 receives the color video stream, and is based on a user input to perform a special effect processing on the color video stream (step S750). In this example, the user desires to superpose a frog picture on the video stream. After the user inputs the frog picture, the image processing module 330 converts the frog picture into the parameter Id=1. Therefore, the frog picture can be identified as a background frog in accordance with the parameter Id=1, and accordingly the background frog is extracted and superposed on the video stream corresponding to the background picture.

In step S760, after the image processing module 330 superposes the frog picture (the background frog) on the video stream, it uses the API “KS property Set” to notify the image driver unit 320 of receiving the processed video stream. The image processing module 330 sends the processed video stream to the image driver unit 320. The image driver unit 320 performs the post-processing on the processed video (step S770). When the image driver unit 320 use the API “KS property Set” to notify the image driver unit 320, it performs the internal set function in order to receive the processed video stream.

In view of the foregoing, it is known that, in the invention, a new special effect can be easily downloaded via the Internet and directly used by the image processing module of the image capture device without replacing a new image processing module. In addition, the special effect downloaded can be compatible completely with current Internet messengers such as MSN messenger or yahoo messenger. Further, the invention can implement the special effect filter with the existing driver configuration at the user mode, such that the resources at the user mode can be used to take complicated 3D image operations. Since the communication protocol between the image processing module and the image driver unit at the user mode is determined, downloading a new special effect becomes easier to add in the image processing module as the communication protocol standard is met. The invention can break the limitation of the API “KS property” which can be used to send bytes only, and send an entire image between the kernel mode and the user mode, which allows the plenty resources at the user mode to be used in the post-processing. Accordingly, the video stream after the post-processing is output by the image driver unit. In this case, the video stream is completely processed by not only the image driver unit 320 at the kernel mode but also the image processing module at the user mode.

Although the present invention has been explained in relation to its preferred embodiment, it is to be understood that many other possible modifications and variations can be made without departing from the spirit and scope of the invention as hereinafter claimed.

What is claimed is:

1. A method for performing image processing in a computer apparatus, the computer apparatus including an image capture device, an image driver unit, an image processing module and an operating system with a user mode and a kernel mode, the method comprising the steps:
an image receiving step, which uses the image driver unit to receive a video stream from the image capture device for performing a pre-processing on the video stream to thereby obtain a color video stream;
a first image delivering step, which uses the image driver unit to send the color video stream to the image processing module, wherein the image driver unit is performed at the kernel mode and the image processing module is performed at the user mode;
an image processing step, which uses the image processing module to perform a special effect processing on the color video stream to thereby produce a processed video stream; and
a second image delivering step, which uses the image processing module to send the processed video stream to the image driver unit for performing a post-processing on the processed video stream to thereby produce a post-processed video stream;
wherein the image processing module performs the special effect processing at the user mode on the color video stream.

2. The method as claimed in claim 1, further comprising a third image delivering step, which uses the image driver unit to send an output of the post-processed video stream to an application program, wherein the application program is performed at the user mode.

3. The method as claimed in claim 2, wherein the operating system is Windows 2000 or XP.

4. The method as claimed in claim 3, wherein the image processing module uses an application programming interface (API) to notify the image driver unit of sending the color video stream to the image processing module.

5. The method as claimed in claim 4, wherein the API is KS property Get.

6. The method as claimed in claim 3, wherein the image processing module uses an application programming interface (API) to notify the image driver unit of receiving the processed video stream.

7. The method as claimed in claim 6, wherein the API is KS property Set.

8. The method as claimed in claim 5, wherein the special effect processing performed by the image processing module is an image enhancement, an image restoration, an image segmentation, an image feature extraction, an image edge detection, an image morphological processing, an image replacement processing, or an image merge processing.

9. The method as claimed in claim 7, wherein the post-processing performed on the processed video stream by the image driver unit is an image brightness processing, or an image edge-enhance processing.

10. The method as claimed in claim 1, wherein the method can be compatible completely with a MSN messenger or yahoo messenger.

11. A system for performing image processing in a computer apparatus, the computer apparatus including an operating system with a user mode and a kernel mode, the system comprising:
an image capture device, which has an image extractor to extract a video stream, and a connection interface;
an image driver unit, which performs a pre-processing and a post-processing, wherein the image driver receives the video stream from the image capture device and performs the pre-processing at the kernel mode on the video stream to thereby obtain a color video stream; and
an image processing module, which is connected to the image driver unit in order to perform a special effect processing at the user mode on the color video stream, to thereby produce a processed video stream;
wherein the image processing module sends the processed video stream to the image driver unit, and the image driver unit performs the post-processing on the processed video stream to thereby produce a post-processed video stream to an application program performed at the user mode.

12. The system as claimed in claim 11, wherein the operating system is Windows 2000 or XP.

13. The system as claimed in claim 12, wherein the image processing module uses an application programming interface (API) to notify the image driver unit of sending the color video stream to the image processing module.

14. The system as claimed in claim 13, wherein the API is KS property Get.

15. The system as claimed in claim 12, wherein the image processing module uses an application programming interface (API) to notify the image driver unit of receiving the processed video stream.

16. The system as claimed in claim 15, wherein the API is KS property Set.

17. The system as claimed in claim 12, wherein the special effect processing performed by the image processing module is an image enhancement, an image restoration, an image segmentation, an image feature extraction, an image edge detection, an image morphological processing, an image replacement processing, or an image merge processing.

18. The system as claimed in claim 12, wherein the post-processing performed by the image driver unit is an image brightness processing, or an image edge-enhance processing.

19. The system as claimed in claim 12, wherein the image capture device is connected with the computer apparatus through an Ethernet, a wireless Ethernet, a universal serial bus (USB), a wireless USB, or an IEEE 1394 serial bus.

20. The system as claimed in claim 12, wherein the system can be compatible completely with a MSN messenger or yahoo messenger.
